(19) United States
(12) Patent Application Publication
(10) Pub. No.: US 2009/0008044 A1
(43) Pub. Date: Jan. 8, 2009

(54) GUIDING ELEMENT WITH A GUIDING PROFILE FOR GUIDING A SCREEN OF A ROLL SCREEN AND A ROLL SCREEN

(76) Inventors: Edwin Floor, Hollandsche Rading (NL); Ramon Floor, Hollandsche Rading (NL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/966,000

(22) Filed: Dec. 28, 2007

(30) Foreign Application Priority Data
Dec. 29, 2006 (NL) 1033152

(51) Int. Cl. E06B 9/17

(52) U.S. Cl. 160/266

(57) ABSTRACT

Guiding element with a guiding section for guiding a descending shutter of a roll-down shutter and a roll-down shutter.

Guiding element (3) with a guiding section (4) for guiding a descending shutter of a roll-down shutter where at least one fixing hole (5) is provided in the guiding section (4) for leading through attachment means with the property that a bottom of the guiding section (4) is provided locally with at least one recess and that one or more fixing holes (5) are provided in the bottom of one or more recesses (6).

The invention relates to a guiding element with a guiding section for guiding a descending shutter of a roll-down shutter where at least one fixing hole has been provided in the guiding section for leading through fixing means. The invention also relates to a roll-down shutter. It should be noted within this context that where in the present application a shutter is involved, a closed rolling grille that may be transparent or non-transparent should not only be understood but also often a metal rolling gate with an open bar structure, as is also applied at many places, may also be involved.

A guiding section of an existing guiding element has in the main a U-shaped section and extends in a longitudinal direction. The known guiding element is split into a first and second part in the longitudinal direction.

One leg of the U-shaped guiding section is provided on the first part and the other leg of the U-shaped guiding section is provided on the second part. Between both legs the U-shaped guiding section has a bottom section which is provided on the first part. The first part lies over the second part where the bottom section can be found and both parts are attached to each other over their length through screws.

The screw heads are countersunk into the guiding section to ensure that the shutter cannot become jammed against the protruding screw heads in relation to the guiding section when it descends. The available, prefabricated screw holes are chamfered using a counterbore when the roll-down shutter is assembled in the guiding section because of this.

The commonly used guiding element has the disadvantage that chamfering the screw holes present in the guiding section using a drill is a laborious and time consuming task. This task has to be performed again when a new roll-down shutter must be assembled. When the first part of the guiding element has a slight wall thickness, it may easily be the case that a screw hole present in the first part is broadened excessively when chamfered.

One of the object of the invention is to provide a guiding element of the type mentioned in the opening lines that allows easy assembly.

A guiding element of the type mentioned in the opening lines has as a property according to the invention that a bottom of the guiding section is provided locally with at least one recess and that at least one fixing hole is provided in a bottom of one or more recesses. The screw head can, therefore, be found in a recess of the guiding section so that the shutter will not jam against the screw head when it descends. The fixing holes do not have to be provided anymore because the respective screw heads no longer have to be countersunk.

A preferred model of the guiding element according to the invention has as a property that at least one recess comprises a local remodelling of the guiding section. The recess can thus be realised relatively easily.

In particular, no material reducing machining is required for this.

A further preferred model of the guiding element according to the invention has as a property that the at least one recess comprises a continuous groove in the longitudinal direction. The groove can, for example, be realised relatively easily and quickly through a rolling process. On the other hand, it is conceivable that the groove, for example, is realised with the assistance of an extrusion process.

A particular modification of the guiding element has as a property that the guiding section determines a housing for the lateral edge section of the shutter and that the guiding element is assembled from a first and second part where the first and second part can be mounted at different positions with regard to each other to vary the width of the housing. This shall ensure that the width of the housing can be adjusted to the thickness dimension of a shutter when assembling a roll-down shutter through suitable mutual mounting of the first and second part. It is not required that a first and/or second part with adjusted/harmonised dimensions be selected for this so that the first and second part can be provided as standard components. The manufacture, storage and distribution of both parts will, thus, be simplified.

A further particular modification of the guiding element has as a property that one or more fixing holes are provided in one part of the guiding element and that the corresponding holes in the other part of the guiding element have been provided where the corresponding holes are located in a width direction of the housing at different positions. The width of the housing is determined by selecting a corresponding hole where subsequently a screw is screwed through at least one fixing hole and the selected corresponding hole to connect one part with the other part. When the screw is screwed in another corresponding hole, the width of the housing changes.

A preferred model of the guiding element has as a property that at least one of the assembled parts of the guiding element is provided with a tubular strengthening section. The guiding element will be given additional strength through the tubular strengthening section. It is, furthermore, conceivable that the guiding element has a load-bearing function as a result of the increased strength thereof for one or more other parts of the roll-down shutter placed on top.

A further preferred model of the guiding element has as a property that the guiding element is provided with at least one, preferably bent, guiding surface for the shutter. When the shutter descends, it will be placed in the guiding element in a flowing manner by the guiding surface.

The invention also makes provisions with regard to a roll-down shutter which has been provided on either side with a guiding element as described above.

The invention also makes provisions with regard to a roll-down shutter comprising a rolling grille and a shaft for rolling up and down the rolling grille where bracket elements have been provided on either side of the shaft that can be attached to a wall where each of the bracket elements is capable and has been set up to at least support the end of the shaft and where a guiding element with a guiding section is provided on either side of the rolling grille for guiding the rolling grille with the property that each bracket element has a wall segment with which the bracket element can be attached to the wall and that a lateral edge of the wall segment is at least in the main aligned with a lateral edge of the guiding section where the lateral bordering area can be found between the wall segment and an adjacent guiding section of a guiding element.

Since the lateral edge of the adjacent component of the guiding section does not protrude in a lateral direction with regard to the lateral edge of the wall segment, the shutter cannot become jammed against it when it descends. Likewise, the shutter cannot be jammed against the lateral edge of the wall segment when it is rolled up. An unhindered descent and ascent of the shutter is thus encouraged.

A preferred model of the roll-down shutter has as a property that each bracket element has a protruding segment with a supporting construction for a respective shaft end and that the protruding segment has been provided along at least a section of the outline thereof with a stiffener formed as one piece. Deformation of the protruding segment is prevented due to the stiffener. Since the stiffener is formed from one piece instead of from individual parts, an additionally strengthening effect is obtained. The stiffener can also have a load-bearing function and/or a fixing function for an enclosure for the roll-down shutter.

A particular modification of the roll-down shutter has as a property that a driving motor is provided to rotate the shaft where the driving motor is mounted on one bracket element of the roll-down shutter where the driving motor is set up on one side of a protruding segment of one bracket element that is turned aside from another bracket element of the roll-down shutter. This model provides a solution when too little space is available between both bracket elements of the roll-down shutter to be able to install the motor at this location. The motor will, in such a case, not be mounted between both bracket elements but outside of this. Only where the motor has been installed, will the roll-down shutter have a larger width locally. This ensures that the roll-down shutter can, thus, be constructed more compactly with regard to a situation where the motor is mounted between both bracket elements.

The invention shall now be further explained based on a model example and a related drawing. The following is shown in the drawing:

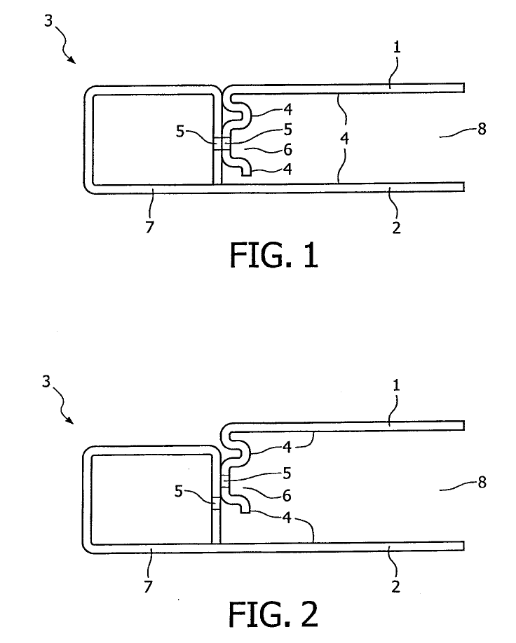

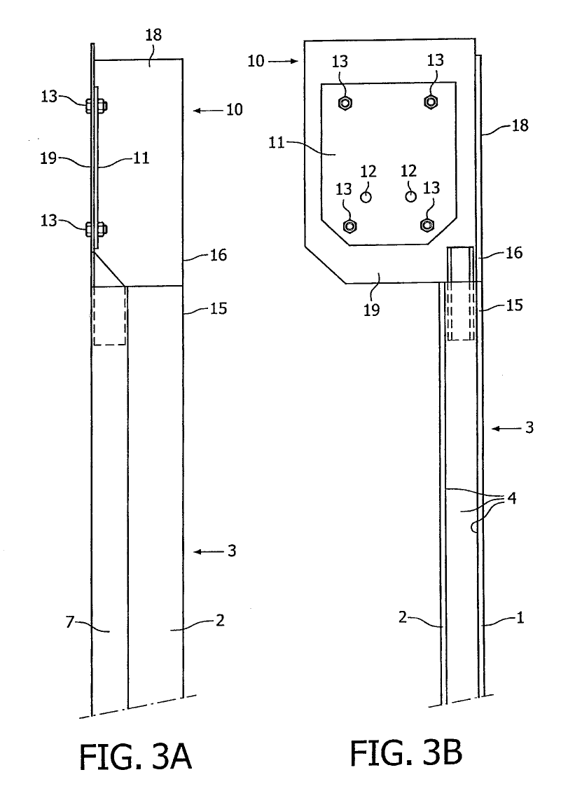

FIG. 1 Shows a model example of a guiding element according to the invention in a cross section. FIG. 2 Shows the guiding element from FIG. 1 where both assembling parts together take up another assembly position.

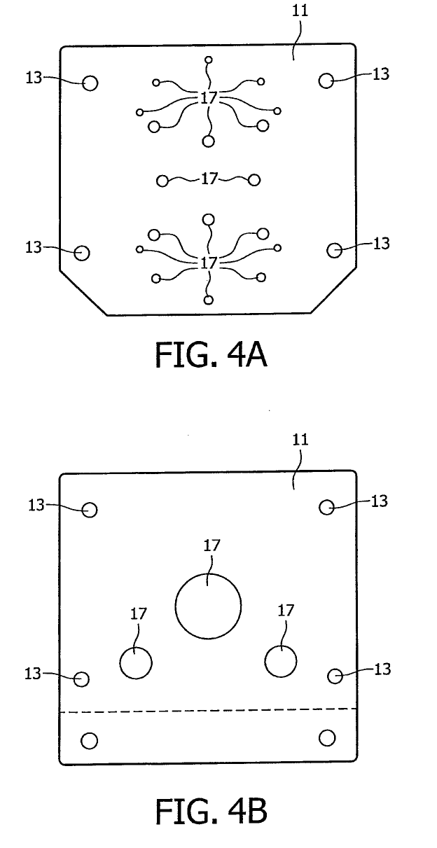

FIGS. 3A-B Show a front view and a side view of the guiding element shown in FIG. 1 in an assembled position with on top a bracket element.

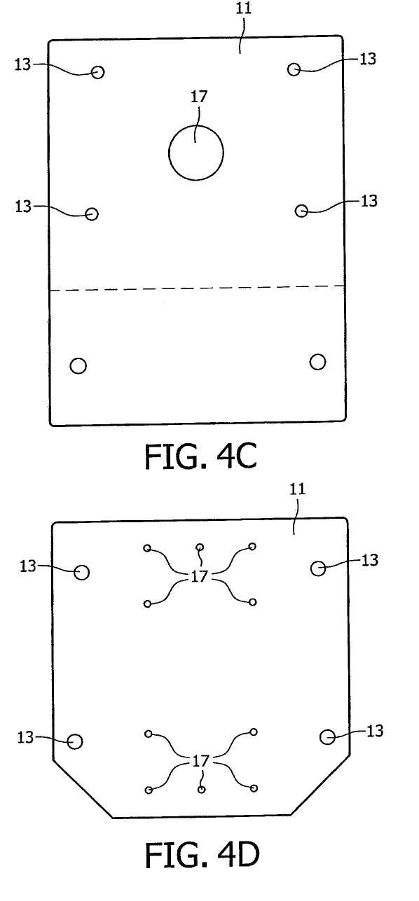

FIGS. 4A-D Show model examples of standard securing plates.

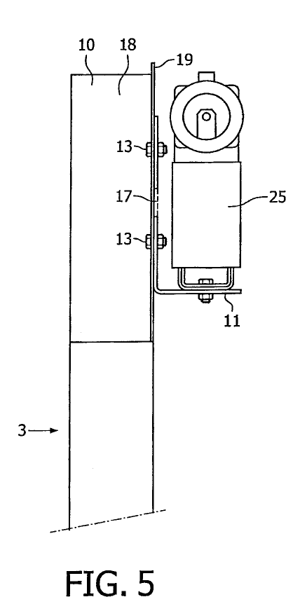

FIG. 5 Shows a bracket element with a motor installed thereon.

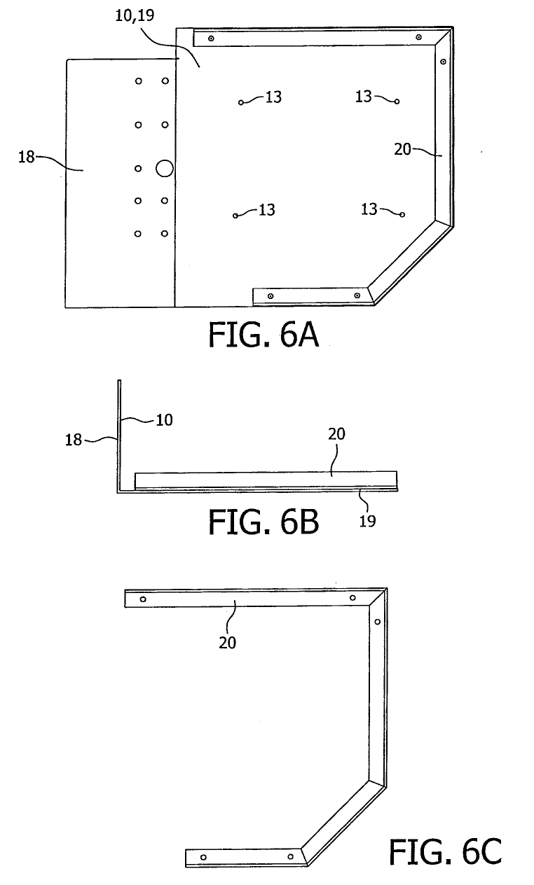

FIGS. 6A-C Show respectively a side view and a top view of a bracket element which is provided with a strengthening section and the strengthening section as a separate component.

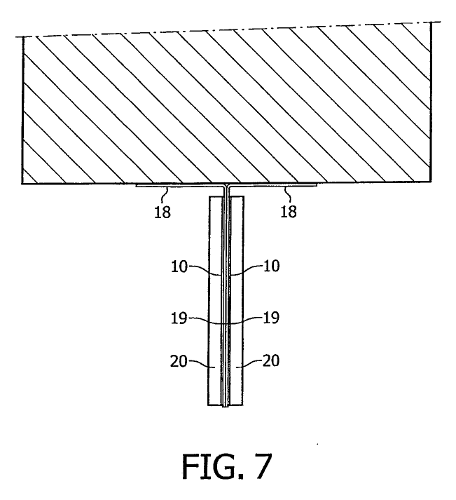

FIG. 7 Shows a top view of two bracket elements mounted against each other.

The figures are for that matter only schematic and have not been drawn to scale. In particular, some dimensions may be shown in an exaggerated fashion to a higher or lesser extent for the sake of clarity. Corresponding parts are indicated in the figures with the same reference numbers as much as possible.

FIG. 1 shows a guiding element 3 with a guiding section 4 with a guiding surface for guiding a lateral edge section of a descending shutter of a roll-down shutter. The guiding section 4 determines a housing 8 for the lateral edge section of the shutter. The guiding element 3 is in a longitudinal direction split in a first part 1 and a second part 2. Screw holes (fixing holes) 5 have been provided at regular interim distances in the longitudinal direction in both parts 1, 2 so that both parts 1, 2 can be screwed together. The guiding section 4 has a continuous groove (recess) 6 in the longitudinal direction. The screw holes 5 present in the first part 1 have been positioned in the groove 6. The second part 2 is provided with a tubular strengthening section 7. The guiding element 3 has been produced from steel and at least the first part 1 with the groove 6 has been realised through a rolling process

Since screw holes 5 of the first part 1 have been added to the groove 6, the screw heads of the screws going through the screw holes 5 cannot protrude with regard to the guiding surface of the guiding section 4. The shutter of the roll-down shutter can, therefore, not jam against the screw heads when it descends. It is no longer necessary to countersink the screw heads in the respective screw holes present in part 1 to ensure that the screw heads do not protrude above the guiding surface of the guiding section 4. Chamfering the screw holes 6 present in the first part 1 is, therefore, no longer required so that the attachment of both parts 1, 2 to each other can take place faster. Since it is no longer necessary to chamfer screw holes, there is also no risk that screw holes are widened too far when chamfered, which would mean that a clearance-free mounting of both parts 1, 2 would no longer be possible. As a result of the groove 6, the contact surface between the guiding section and the shutter is also reduced. The shutter shall, therefore, move along the guiding surface of the guiding section 4 with less friction.

FIG. 2 shows the guiding element 3 from FIG. 1 where now, however, the first part 1 has a different mounting position with regard to the second part 2. This means that the width of a housing 8 is enlarged with regard to the housing 8 shown in FIG. 1. To ensure that both parts 1, 2 can, therefore, be screwed together, a corresponding screw hole is drilled in the second part 2 next to the shown screw hole 5. Alternatively, a number of rows of prefabricated screw holes can be provided in the second part 2 where the rows of screw holes are distributed in the width direction of the housing 8. A required width of the housing 8 can then be realised by selecting a suitable row of screw holes in the second part 2 when screwing together both parts 1, 2. Another option to vary the width of the housing 8 is to produce part 1 in different (standard) dimensions. A required width of the housing 8 will then be realised by selecting the matching part 1. Both parts 1, 2 can always be provided as standard components. This will ensure that the production, storage and distribution of both parts 1, 2 is simplified and that a roll-down shutter can be assembled more quickly.

FIGS. 3A and 3B show the guiding element 3 in their assembled state with on top a bracket element 10. The longitudinal groove 6 in the guiding section 4 of the guiding element 3 has not been shown in FIG. 3B to guarantee proper insight can be provided. The roll-down shutter has been provided on either side with such a guiding element 3 and bracket element 10. The bracket element 10 has a wall segment 18 for attachment to a wall. The bracket element 10 also has a protruding segment 19 with a supporting construction for a respective end of a shaft for the descent and ascent of the shutter of the roll-down shutter. The supporting construction comprises an securing plate 11 screwed on to the protruding segment 19 with openings 12. Protruding pins of a bearing block for the support of the end of the shaft can be received by the openings 12 to mount the bearing block. The bracket element 10 is given additional strength by applying an securing plate 11.

A lateral edge 16 of the wall segment 18 is aligned with a lateral edge 15 of an adjacent part of the guiding section 4. This ensures that the shutter cannot become jammed against a protruding edge of the guiding section 4 with regard to the wall segment 18 when it descends. Likewise, the shutter cannot be jammed against a protruding edge of the wall segment 18 with regard to the guiding section 4 when rolled up.

The bracket element 10 and the securing plate 11 have both been provided with prefabricated holes 13 for their mutual attachment using bolts and nuts. If the holes 13 had been classified according to the corner points of a square, the securing plate 11 could easily be screwed in the incorrect position, for example, twisted by 90°, to the bracket element 10. The holes 13 have, therefore, been classified according to the corner points of a rectangle to ensure that the securing plate 11 cannot be mounted in the incorrect position. The securing plate 11 is available in a number of standard models as shown in FIGS. 4A- D. The openings 17 that have been provided in the securing plates 11 can, for example, be used for mounting a motor, a fall protection for the shutter, a bearing block or for leading through a shaft end. By using the standard securing plates 11, it can be avoided that holes of the appropriate size have to be made when assembling a roll-down shutter in a bracket element 10 for the mounting of the different components of the roll-down shutter such as has been the usual method up to now. This will ensure that a roll-down shutter can be assembled faster and simpler after it has been ordered and savings can be made on the labour costs or wages of installation personnel. A lower level of professional know-how is required to mount the roll-down shutter and the relevant components of the roll-down shutter can be made from stock.

An securing plate 11 can be attached on either side of a protruding segment 19. When, for example, too little space is available between two bracket elements 10 mounted on either side of the roll-down shutter for the in-between mounting of a motor or a bearing, the securing plate 11 can be mounted to one of the sides of the protruding segment of the bracket element that is turned away from the other bracket element. This last option is, for example, shown in FIG. 5 where a motor 25 has been mounted on the securing plate 11. By, thus, mounting the securing plate 11 with the motor 25, it is avoided that the roll-down shutter must be made wider for the full height thereof to ensure the motor 25 can be mounted between both bracket elements 10. Instead, the roll-down shutter only has an enlarged width where the motor 25 can be found so that the roll-down shutter takes up less space.

A bracket element 10 is shown in FIGS. 6A-B of which the protruding segment 19 is provided along a section of the outline edge thereof with a detachable stiffener 20 formed as a whole. Deformation of the bracket element 10 is prevented due to the stiffener 20, and, in particular, since it is produced as a whole. By disassembling the stiffener 20, easier access shall be obtained to the components of the roll-down shutter such as, for example, a motor or a bearing when performing maintenance or repair work. The stiffener 20 is capable of at least partially supporting an enclosure of the roll-down shutter and/or to attach thereon the enclosure.

Two bracket elements 10 can be mounted against each other as shown in FIG. 7. This ensures that a roll-down shutter can be mounted immediately next to another roll-down shutter. The construction of both roll-down shutters is also strengthened due to this. On the other hand, it is conceivable that such a construction is only applied to one roll-down shutter for its strengthening.

Since standard components of the roll-down shutter such as both parts 1, 2, the securing plate 11, the bracket element 10 and the stiffener 20 will not have to or only slightly have to be processed when being installed, a coating or paint layer applied beforehand will remain intact to a large extent when installation takes place.

Although the invention was further explained based on merely a few model examples, it should be clear that this does not limit the invention by any manner or means. On the contrary, there are still many variations and realisation forms that are possible within the framework of the invention for an average professional.

Conclusions

1. Guiding element with a guiding section for guiding a descending shutter of a roll-down shutter where at least one fixing hole is provided in the guiding section for leading through attachment means with the property that a bottom of the guiding section is provided locally with at least one recess and that one or more fixing holes are provided in the bottom of one or more recesses.

2. Guiding element according to conclusion 1 with the property that at least one recess comprises a local transformation of the guiding section.

3. Guiding element according to conclusion 1 or 2 with the property that at least one recess comprises a continuous groove in the longitudinal direction.

4. Guiding element according to conclusion 1, 2 or 3 with the property that the guiding section determines a housing for the lateral edge section of the shutter and that the guiding element is made up of a first and second part where the first and second part can be mounted at different positions with regard to each other to vary the width of the housing.

5. Guiding element according to conclusion 4 with the property that at least one fixing hole is provided in one part of the guiding element and that corresponding holes have been provided in another part of the guiding element where the corresponding holes lie at different positions in the width direction of the housing.

6. Guiding element according to one or more of the aforementioned conclusions with the property that at least one of the composing parts of the guiding element is provided with a tubular strengthening section.

7. Guiding element according to one or more of the aforementioned conclusions with the property that the guiding element is provided with at least one, by preference bent, guiding surface for the shutter.

8. Roll-down shutter which has been provided on either side with a guiding element according to one or more of the aforementioned conclusions.

9. Roll-down shutter comprising a rolling grille and a shaft for the rolling up and down of the rolling grille where bracket elements have been provided that can be attached to a wall on either side of the shaft where each of the bracket elements is capable and has been set up to support at least an end of the shaft and where a guiding element is provided with a guiding section on either side of the rolling grille for guiding the rolling grille with the property that each bracket element has a wall segment with which the bracket element can be attached to the wall and that a lateral edge of the wall segment at least in the main is aligned with a lateral edge of the guiding section where a lateral bordering area between the wall segment and an adjacent guiding section of a guiding element can be found.

10. Roll-down shutter according to conclusion 9 with the property that each bracket element has a protruding segment with a supporting construction for a respective shaft end and that the protruding segment has been provided along at least a section of the outline thereof with a stiffener formed as one piece.

11. Roll-down shutter according to conclusion 9 with the property that a driving motor is provided to rotate the shaft where the driving motor is mounted on one bracket element of the roll-down shutter where the driving motor is set up on one side of a protruding segment of one bracket element that is turned aside from another bracket element of the roll-down shutter.

1. A guiding element with a guiding section for guiding a descending shutter of a roll-down shutter, said guiding element comprising:
at least one recess disposed in a portion of the guiding section; and
at least one hole disposed in said at least one recess to receive a fastener.

2. A guiding element according to claim 1 wherein said at least one recess comprises an integral portion of the guiding section bent in a localized area to form said at least one recess.

3. A guiding element according to claim 1 wherein said at least one recess comprises a continuous groove extending in the a longitudinal direction.

4. A guiding element according to claim 1 wherein the guiding section defines a housing for the lateral edge section of the shutter and wherein the guiding element comprises first and second parts wherein said first and said second parts can be mounted at different positions with regard to each other to vary the width of said housing.

5. A guiding element according to claim 4 wherein said at least one hole is provided in said first part of the guiding element and corresponding holes are provided in said other part of the guiding element and wherein said corresponding holes lie at different positions in the width direction of said housing.

6. A guiding element according to claim 4 wherein at least one of said parts of the guiding element are provided with tubular strengthening section.

7. A guiding element according to claim 1 wherein the guiding element is provided with at least one, surface to guide movement of the descending shutter.

8. A roll-down shutter in combination with two guiding elements defined according to claim 1, wherein the guiding elements are disposed along opposite sides of the shutter.

9. A roll-down shutter comprising a rolling grille and a shaft for the rolling up and down of the rolling grille, bracket elements attachable to a wall on either side of the shaft, with each of the bracket elements being capable of supporting one end of the shaft, and a guiding element provided with a guiding section on either side of the rolling grille for guiding the rolling grille, wherein each bracket element has a wall segment attachable to the wall and a lateral edge of the wall segment substantially aligned with a lateral edge of the guiding section defining a lateral bordering area between the wall segment and an adjacent guiding section of a guiding element.

10. A roll-down shutter according to claim 9 wherein each bracket element has a protruding segment to support a respective shaft end of the rolling grille, said protruding segment further comprising a stiffener disposed along the periphery thereof.

11. A roll-down shutter according to claim 9 further comprising a driving motor that is provided to rotate the shaft on one bracket element of the roll-down shutter and wherein the driving motor is connected to one side of a protruding segment of one bracket element that is opposite from the other bracket element.

12. A guiding element according to claim 7 wherein said at least one guiding surface comprises a bent portion of the guiding element.

13. A guiding element according to claim 1 wherein the hole is a screw hole and the fastener comprises a screw.

14. A guiding element according to claim 1 wherein said portion of the guiding section comprises the bottom of the guiding section.
